(19) United States
(12) Patent Application Publication
(10) Pub. No.: US 2008/0035450 A1
(43) Pub. Date: Feb. 14, 2008

(54) SLAT DRIVEN POSITIVE DISPLACEMENT SORTER

(75) Inventors: Ted W. Haan, Wyoming, MI (US); David H. Cotter, Coopersville, MI (US)

Correspondence Address: VAN DYKE, GARDNER, LINN & BURKHART, LLP, SUITE 207, 2851 CHARLEVOIX DRIVE, S.E., GRAND RAPIDS, MI, 49546, US

(73) Assignee: DEMATIC CORP., Grand Rapids, MI (US)

(21) Appl. No.: 11/738,573

(22) Filed: Apr. 23, 2007

Related U.S. Application Data
(60) Provisional application No. 60/745,668, filed on Apr. 26, 2006.

(51) Int. Cl. B65G 47/10

(52) U.S. Cl. 198/370.02

(57) ABSTRACT

An article sorter is made up of a web defined by a plurality of interconnected, laterally elongated, slats. An upper portion of the web defines a longitudinally extending conveying surface. Each of the slats has a generally planar upper surface forming a portion of the conveying surface and a lower surface opposite the upper surface. A plurality of pusher shoes travel laterally of the conveying surface to laterally displace articles on the conveying surface. A drive assembly is provided to propel the web. The drive includes at least one sprocket and a motor. The motor rotates the sprocket(s). The sprocket(s) engage the lower surface of the slats.

### CROSS REFERENCE TO RELATED APPLICATION

This application claims priority from U.S. provisional patent application Ser. No. 60/745,668, filed on Apr. 26, 2006, the disclosure of which is hereby incorporated herein by reference in its entirety.

### BACKGROUND OF THE INVENTION

The present invention is directed to article sorters and in particular to positive displacement sorters in which pusher shoes traveling with the conveying surface selectively laterally displace articles on the conveying surface such as to a selected spur.

In one type of positive displacement sorter, such as disclosed in commonly assigned U.S. Pat. No. 5,127,510, the web defining the conveying surface is made up of a plurality of slats that are connected at opposite ends to endless chains. The pusher shoes travel laterally along one or more slats. Wheels mounted to the chain support the web. The chains are driven by motor driven chain sprockets which propel the web.

In another type of positive displacement sorter, such as disclosed in commonly assigned U.S. Pat. No. 6,814,216, the web defining the conveying surface is made up of a plurality of slats that are each supported by one or more wheels supporting each slat and members interconnecting adjacent slats. The pusher shoes travel laterally along one or more slats. The web is driven by a linear motor system made up of motor primaries distributed beneath the web and secondary plates attached to the slats.

### SUMMARY OF THE INVENTION

An article sorter, according to an aspect of the invention, is made up of a web defined by a plurality of interconnected, laterally elongated, slats. An upper portion of the web defines a longitudinally extending conveying surface. Each of the slats has a generally planar upper surface forming a portion of the conveying surface and a lower surface opposite the upper surface. A plurality of pusher shoes travel laterally of the conveying surface to laterally displace articles on the conveying surface. A drive assembly is provided to propel the web. The drive includes at least one sprocket and a motor. The motor rotates the sprocket(s). The sprocket(s) engage the lower surface of the slats.

These and other objects, advantages and features of this invention will become apparent upon review of the following specification in conjunction with the drawings.

### BRIEF DESCRIPTION OF THE DRAWING

FIG. 1 is a top plan view of an article sorter according to the invention, with upstream and downstream portions of the conveying surface removed to reveal internal details thereof;

FIG. 2 is a side elevation taken from the direction II-II in FIG. 1;

FIG. 3 is the same view as FIG. 2 with the side member removed to reveal internal structure thereof;

FIG. 4 is a bottom plan view taken from the direction IV-IV in FIG. 2;

FIG. 5 is a side elevation of the drive assembly driving the web;

FIG. 5a is an enlargement of a portion of the drive assembly in FIG. 5 to show greater detail thereof;

FIG. 6 is a side elevation of a sprocket;

FIG. 7 is an end elevation of the sprocket in FIG. 6;

FIG. 8 is a perspective view of a sprocket core;

FIG. 9 is a side elevation of the sprocket core in FIG. 8;

FIG. 10 is a side elevation of a wheel assembly; and

FIG. 11 is a top plan view of a diverter switch assembly.

### DETAILED DESCRIPTION OF THE PREFERRED EMBODIMENT

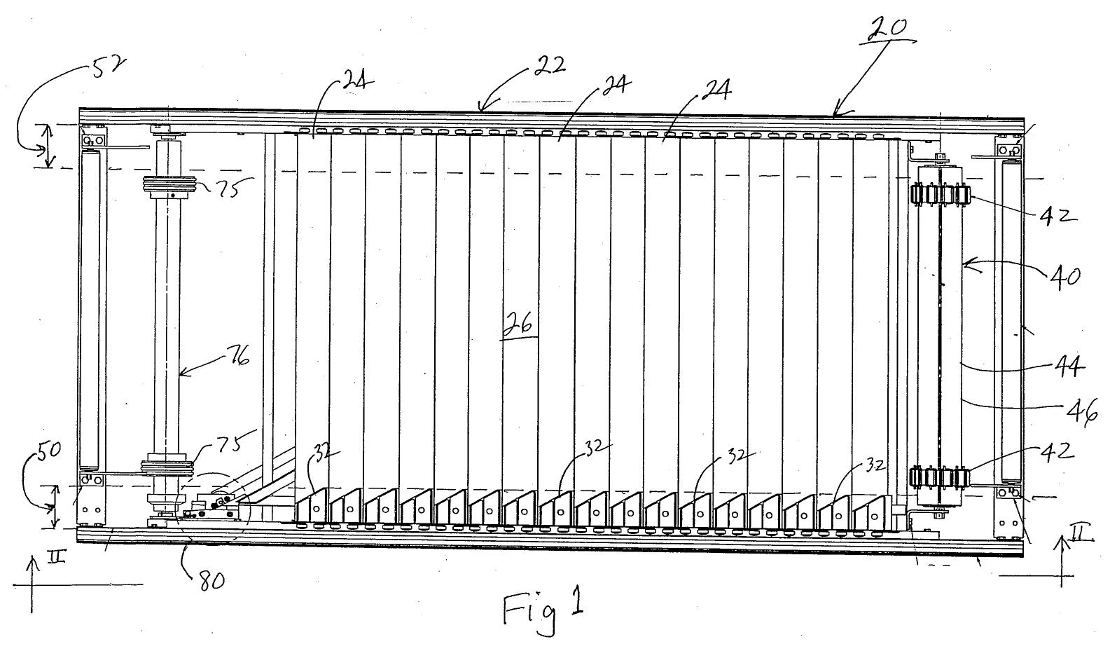

Referring now to the drawings and the illustrative embodiments depicted therein, an article sorter 20 is made up of an endless web 22 that is moveably supported by a frame assembly 23 (FIG. 1). Web 22 is made up of a plurality of laterally elongated slats 24. An upper portion of web 22 defines a conveying surface 26 moving in a longitudinal direction. Each slat 24 has an upper surface 28 and a lower surface 30. Upper surface 28 is generally flat, or planar, such that article sorter 20 is known as a flat-top sorter. It should be understood that considerable variation in the shape of upper surface 28 from a true plane can be accommodated without negating it being generally flat or planer. Article sorter 20 additionally includes a plurality of pusher shoes 32 which travel with the web in the longitudinal direction and can be diverted laterally in order to displace an article traveling on conveying surface 26. Pusher shoes 32 travel along one or more slats and can be of any configuration known in the art. Examples of pusher shoes 32 are disclosed in commonly assigned U.S. Pat. Nos. 5,127,510; 6,814,216; and 6,860,383; and published application 2005/0023108, the disclosures of which are hereby collectively incorporated herein by reference. Also, a lateral stabilizer 33 is defined between each pusher shoe 32 and slat 24 as described in the preceding patents.

A divert switch assembly 80 selectively diverts one or more pusher shoes 32 to a diverting rail 82 to divert the pusher shoe(s) from a non-diverted state, represented by lateral portion 50 of the conveying surface, to a diverted state, represented by lateral portion 52 of the conveying surface. This lateral movement of the pusher shoe(s) displaces an article, such as to a take-away spur (not shown) for sortation. Diverted pusher shoes are returned to a non-diverted state by a return rail 84. In the illustrated embodiments, article sorter 20 is shown with a single divert switch assembly and diverting rail to provide the ability to divert an article to a single spur. However, multiple such divert switch and diverting rail combinations can be provided for article sorter 20 to allow sortation to multiple spurs.

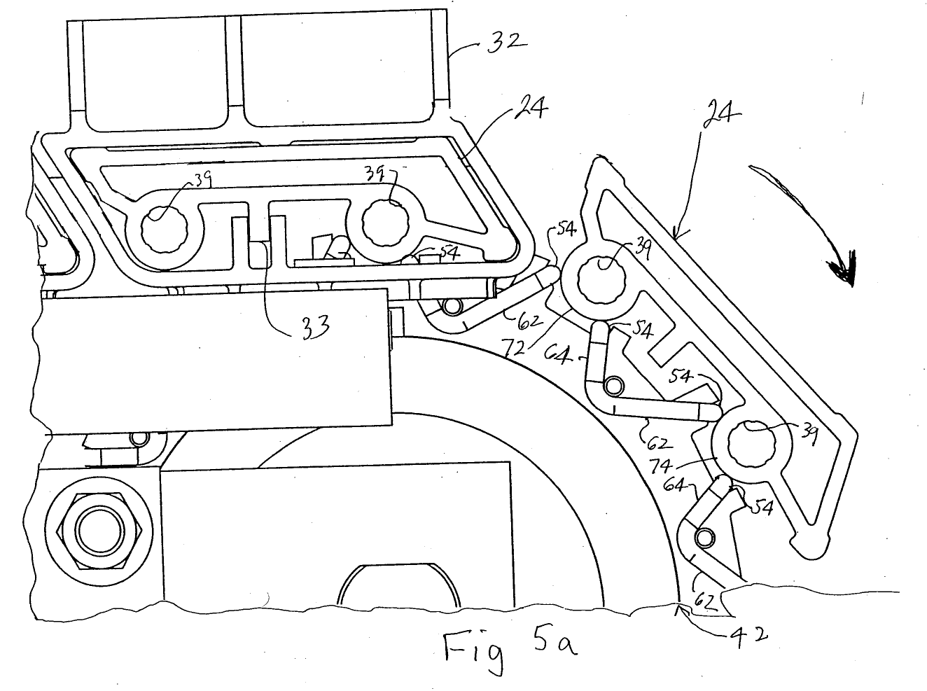

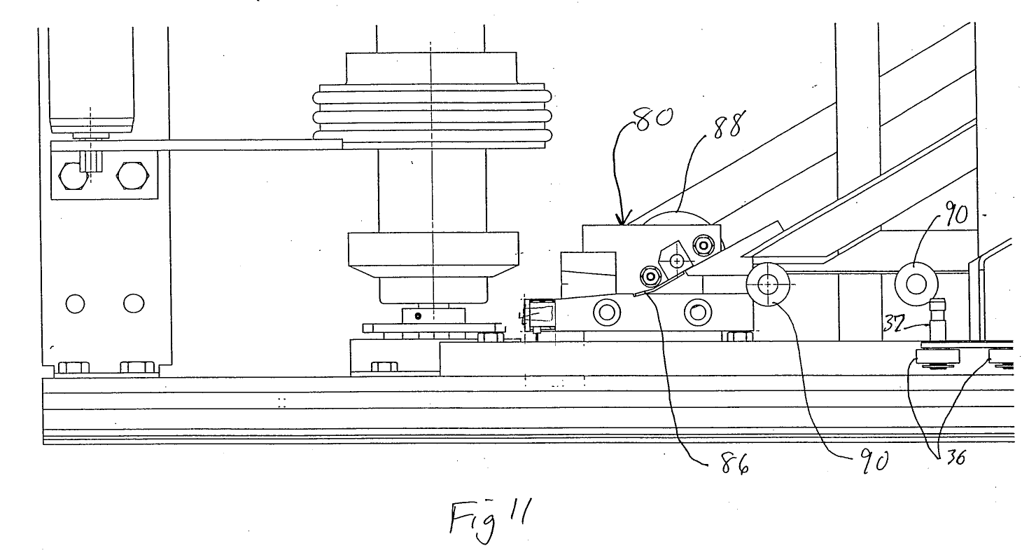

Web 22 is supported on frame assembly 23 by a wheel assembly 34. Wheel assembly 34 includes a series of wheels 36 and links 38 (FIG. 10). In the illustrated embodiment, two wheels are mounted to each end of each slat 24 and adjacent wheels of adjacent slats are joined by links 38. Links 38 pivot about the axles 37 of the joined wheels to accommodate rotation between slats as they move around the ends of the web, as illustrated in FIGS. 5 and 5a. Wheels 36 are rotatably mounted to their respective slats by the fixed positioning of their respective axle 37 in an opening 39 in their slat. The axle may be fixed to the slat by press-fit, by fasteners, or the like. Other arrangements for interconnecting and supporting slats 24, such as chains, are known in the art and may be used without deviating from the spirit of the present invention.

Web 22 is driven by a drive assembly 40. Drive assembly 40 includes at least one sprocket 42, although two are used in the illustrated embodiment, and an electric motor 44 for rotating the sprocket(s). Motor 44 may be in the form of a motorized roller in which the motor windings are internal to the roller and drive an outer shell 46 to which the sprocket(s) are attached. Such motorized rollers are well known in the art and come in various configurations including alternating current, direct current, gear driven, direct driven, and the like. In the illustrated embodiment, motor 44 is a direct driven motorized roller having a 110 millimeter diameter outer shell 46 and a motor that is operated at 48 volts direct current. Alternatively, sprocket(s) 42 may be shaft mounted and driven by an external motor rotating the shaft. The use of an external motor may be especially effective for longer conveying surfaces, such as ones which provide sortation to multiple spurs.

Each sprocket is positioned laterally between lateral portion 50 of conveying surface 26, where non-diverted pusher shoes are located, and lateral portion 52 of the conveying surface, where diverted pusher shoes are located (FIG. 1). This placement of sprocket(s) 42 avoids interference with the pusher shoes while allowing the pusher shoes to be closer to the lateral edge of the conveying surface than if the sprocket(s) were to be located at extreme ends of shell 46. This reduces the overall width of the conveying surface without restricting the article conveying area and ensures a more reliable divert by providing guidance of the article until it is essentially fully off of the conveying surface.

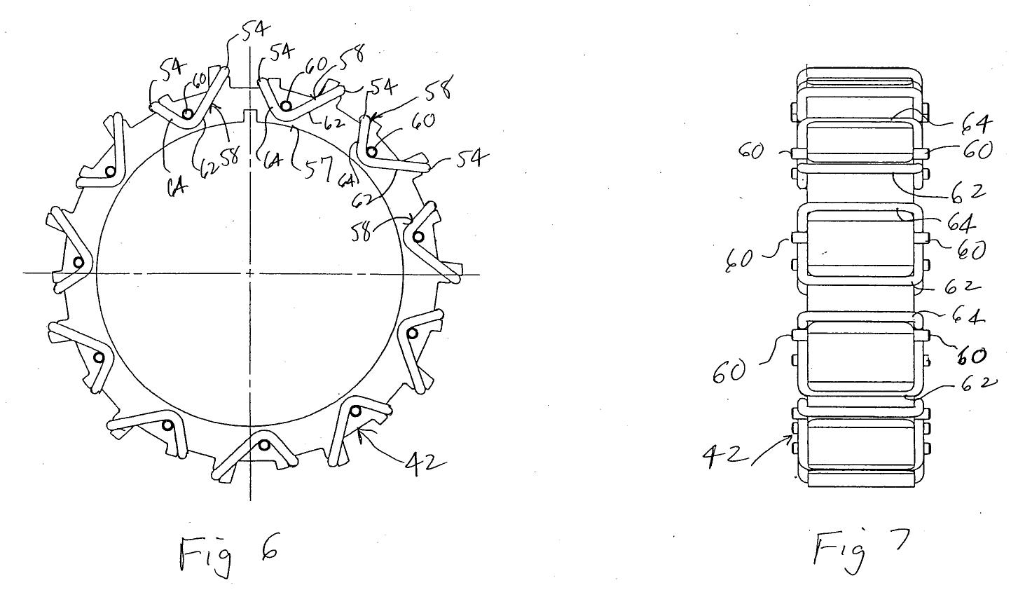

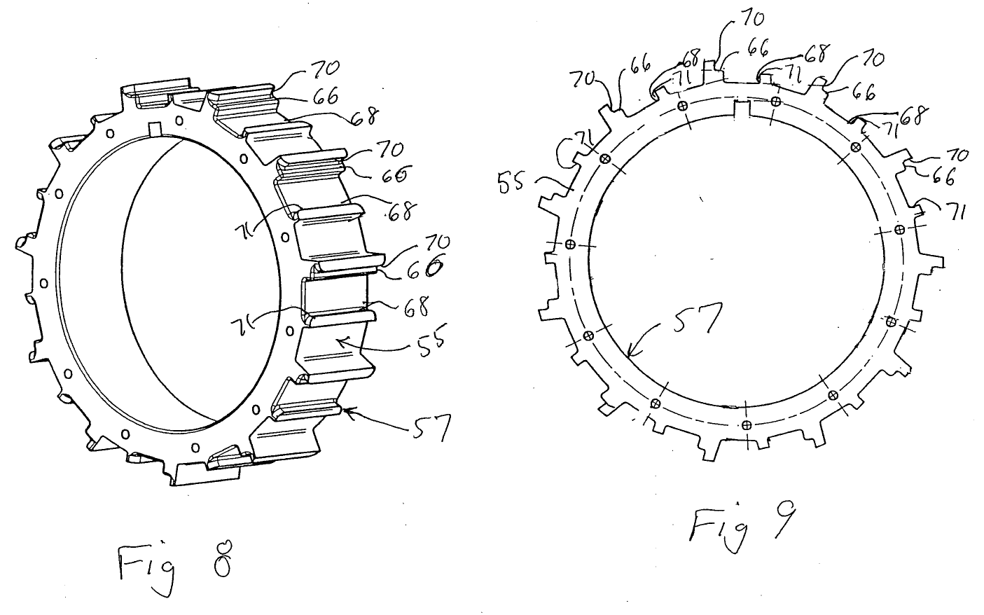

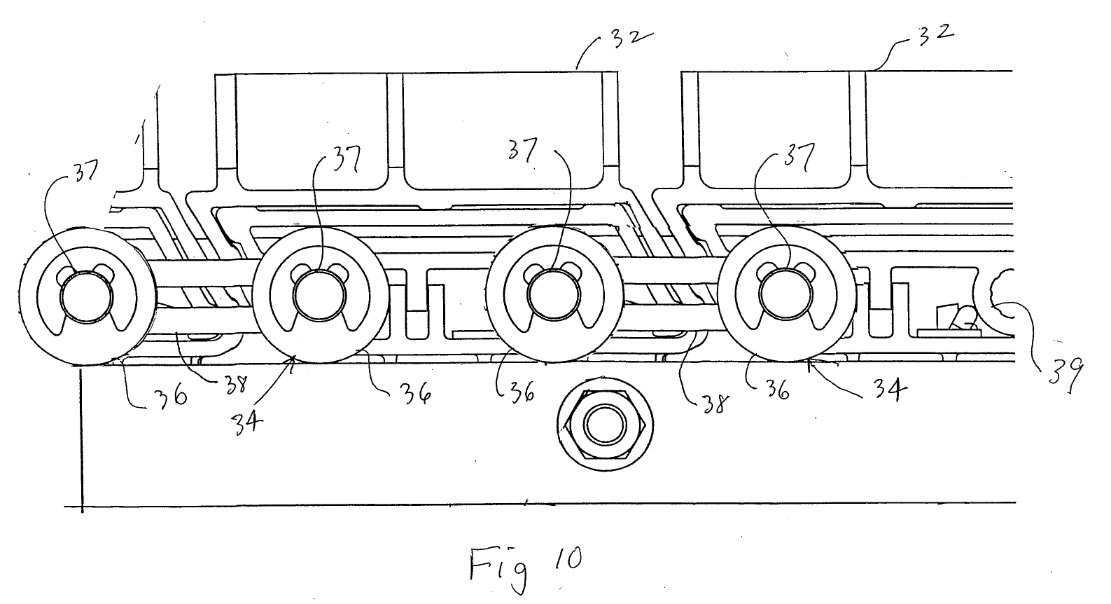

Each sprocket 42 has portions 54 that engages a slat in order to propel the web. Portions 54 are made from an impact absorbing material. This has the effect of significantly reducing noise generated by the driving of the web. In the illustrated embodiment, the material of portions 54 is a polymeric material, specifically polyurethane. Other impact absorbing material may be used. Web engaging portions 54 are provided in the illustrated embodiment by a series of bands, such as O-rings 58, that are stretched across the face 55 of a core 57. O-rings 58 are stretched around pins 60 that protrude laterally from opposite sides of core 57. This divides each O-ring into a first lobe 62 and a second lobe 64 stretched across the face 55 of core 57. When viewed from the side as illustrated in FIG. 6, first lobe 62 is a greater distance from the center of rotation of core 57 than is second lobe 64. First lobe 62 is positioned in this manner by a first land 66 and second lobe 64 is positioned in this manner by a second land 68, with first land 66 being elevated with respect to the second land. First lobe 62 is also supported by a first adjacent surface 70, extending perpendicular to first land 66. Second lobe 64 is also supported by a second adjacent surface 71 extending perpendicular to second land 68. As will be explained in more detail below, first lobe 62 both supports and propels a slat 24 while second lobe 64 supports the slat.

Each slat 24 includes a first protrusion 72 and a second protrusion 74 defined in lower surface 30. First and second lobes 62, 64 support and propel the slat by acting upon protrusions 72 and 74. In the illustrated embodiment, protrusions 72, 74 also define openings 39 for mounting of wheels 36. As can best be seen by reference to FIGS. 5 and 5a, each protrusion 72, 74 is cradled between a slat engaging portion 54 of first lobe 62 of one O-ring 58 and a slat engaging portion 54 of second lobe 64 of an adjacent O-ring. The slat engaging portion 54 of first lobe 62 engages higher on the protrusion to ensure that rotational force of the sprocket is transferred to the slat and, hence, to the web.

The use of urethane O-rings has several advantages. The core of sprocket 42 can be made of a more durable material, such as steel, aluminum, or the like, while still providing an impact absorbent interface to the slats. Also, the O-rings can be readily assembled and readily replaced for maintenance purposes. Also, this configuration is more economical than making the entire sprocket from urethane. O-rings are less expensive than an entire urethane sprocket.

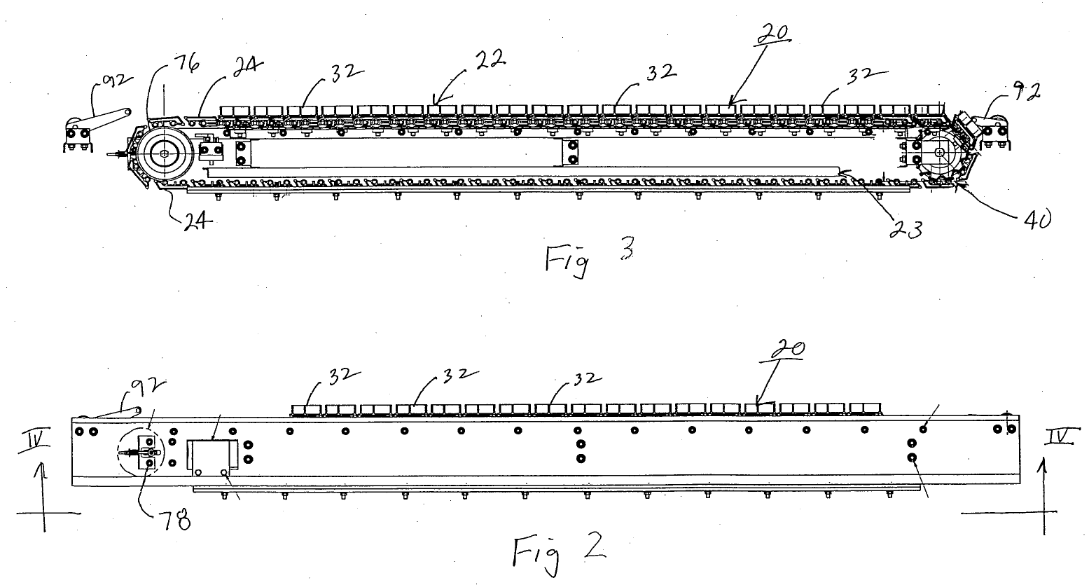

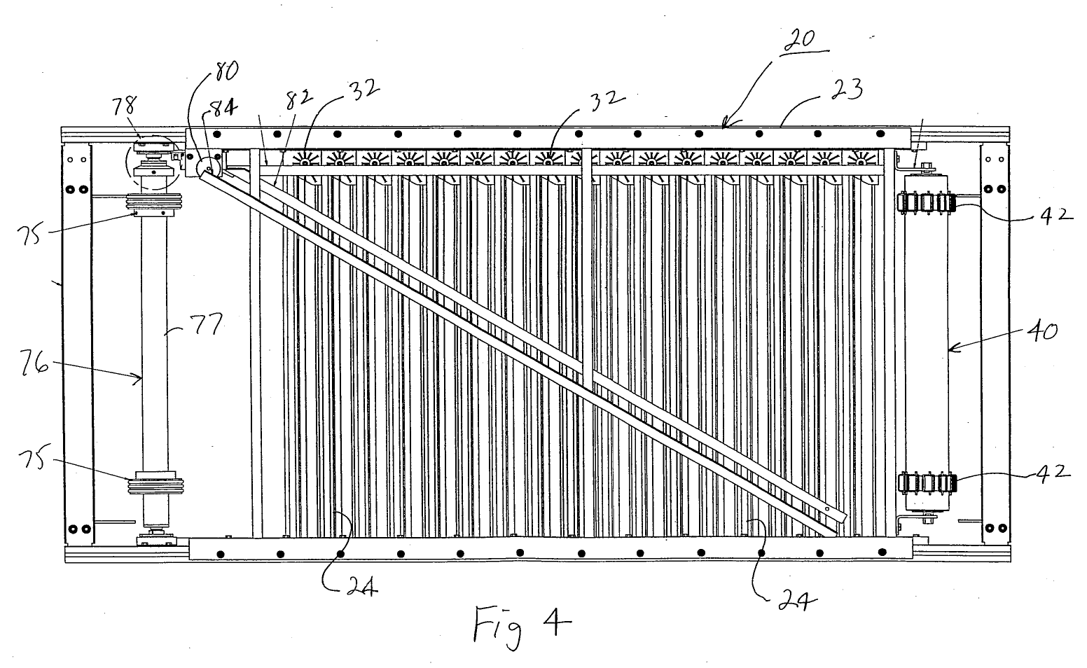

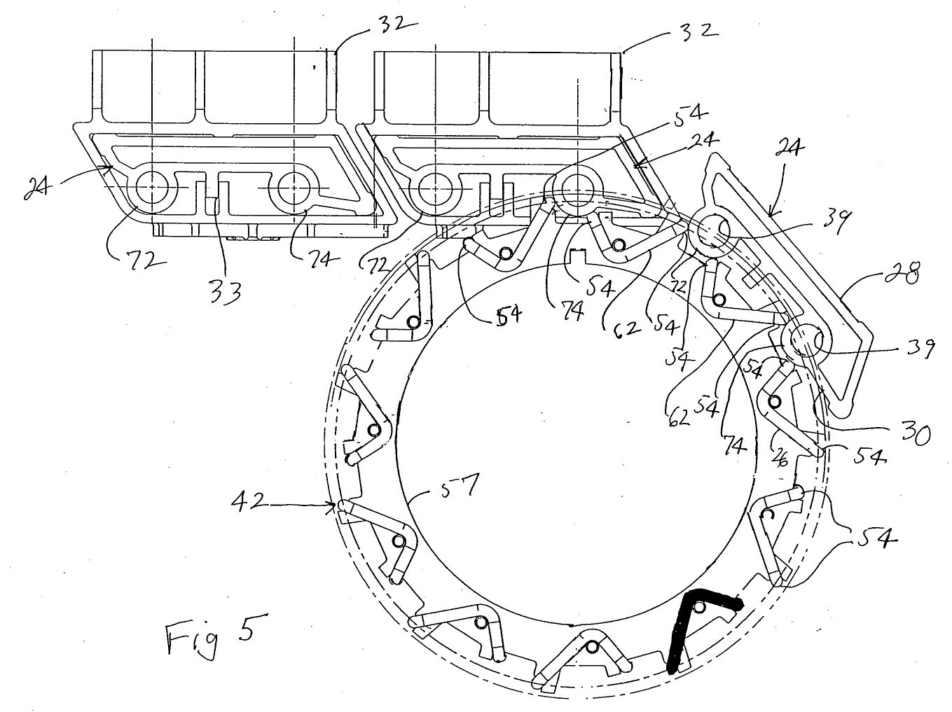

An end of web 22 opposite drive assembly 40 includes an idler pulley assembly 76. Idler pulley assembly 76 includes a pair of pulleys 75 rotatably mounted by a shaft 77. A take-up assembly 78 is provided to idler pulley assembly 76 to remove any slack from the web and accommodate expansion and contraction of the web, such as due to temperature. In the illustrated embodiment, take-up assembly 78 includes a spring-biasing member as best illustrated in FIG. 2. Transition members 92 provide transition from a feed conveyor (not shown) feeding articles to conveying surface 26 and between conveying surface 26 and a take-away conveyor (not shown) taking away articles exiting the end of conveying surface 26.

Diverting switch assembly 80 includes an upstream facing divert arm 86 and a rotary solenoid 88 for selectively rotating arm 86 between a divert position and a non-divert position (FIG. 11). In the divert position illustrated in FIG. 11, the divert arm intercepts the pin of a diverting pin and bearing assembly 90 extending beneath the associated pusher shoe and directs the pin and bearing assembly to diverting rail 82. When not in a divert position, the divert arm is retracted and allows the pin and bearing assembly 90 to continue along in a longitudinal direction. An advantage of such a divert switch assembly is that rotary solenoid 88 can be controlled to move arm 86 to a divert position before the diverting pin and bearing assembly of the prior pusher shoe has fully cleared the divert switch assembly. This increases the speed of the divert cycle. A faster divert speed cycle allows the length of slats 24 in the direction of movement of web 22 to be shorter without sacrificing speed of the conveying surface. It should be understood that other types of divert switch assemblies can be used such as vertical diverters of the type disclosed in commonly assigned U.S. Pat. No. 5,038,912 or magnetically actuated diverters of the type disclosed in commonly assigned U.S. Pat. No. 6,615,972, the disclosures of which are both incorporated herein by reference.

Thus, it is seen that the present invention provides a new and unique positive displacement sorter. The article sorter can be made from fewer components than previous sorters. It can also be made lighter in weight and narrower in width without sacrificing article conveying width. This allows positive displacement sortation, which is especially advantageous for sorting certain types of articles, to be used in more applications. For example, the article sorter may be made to conform to a width that is slightly larger than the width of the rest of the article conveyors in the system, may be suspended from the roof supports along with the rest of the conveyors, and the like.

Changes and modifications in the specifically described embodiments can be carried out without departing from the principles of the invention which is intended to be limited only by the scope of the appended claims, as interpreted according to the principles of patent law including the doctrine of equivalents.

The embodiments of the invention in which an exclusive property or privilege is claimed are defined as follows:

1. An article sorter, comprising:
a web defined by a plurality of interconnected laterally elongated slats, an upper portion of said web defining a longitudinally extending conveying surface, each of said slats having a generally planar upper surface forming a portion of said conveying surface and a lower surface opposite said upper surface;
a plurality of pusher shoes adapted to travel laterally of said conveying surface to laterally displace articles on said conveying surface;
a drive assembly, said drive assembly propelling said web, said drive assembly including at least one sprocket and a motor, said motor rotating said at least one sprocket, said at least one sprocket engaging said lower surface of said slats.

2. The article sorter as claimed in claim 1 wherein said pusher shoes are at a first lateral portion of said web when in a non-diverted state and a second opposite lateral portion of said web when in a diverted state, said pusher shoes traveling between said first and second lateral portions to divert an article, wherein said at least one sprocket engages said slats between said first and second lateral portions of said web.

3. The article sorter as claimed in claim 1 wherein said at least one sprocket comprises at least two sprockets.

4. The article sorter as claimed in claim 1 wherein said at least one sprocket includes a portion engaging said slats, said portion engaging said slats made from an impact absorbing material.

5. The article sorter as claimed in claim 4 wherein said impact absorbing material comprises a polymeric material.

6. The article sorter as claimed in claim 5 wherein said polymeric material comprises polyurethane.

7. The article sorter as claimed in claim 4 wherein said portion engaging said slats is defined by a plurality of O-rings.

8. The article sorter as claimed in claim 7 including pins extending from opposite lateral surfaces of said at least one sprocket, said O-rings stretched over opposite ones of said pins.

9. The article sorter as claimed in claim 7 wherein each of said O-rings comprises first and second lobes, said first and second lobes engaging said slats.

10. The article sorter as claimed in claim 9 wherein said first lobe provides support to a slat generally perpendicular to said lower surface and provides thrust to that slat in the direction of movement of said web and wherein said second lobe provides support to that slat generally perpendicular to said lower surface.

11. The article sorter as claimed in claim 10 wherein said first lobe is supported by a first land of said at least one sprocket and said second lobe is supported by a second land of said at least one sprocket.

12. The article sorter as claimed in claim 11 wherein said first lobe is further from a center of rotation of said at least one sprocket than is said second lobe.

13. The article sorter as claimed in claim 11 including an adjacent surface perpendicular to said first land, said adjacent surface providing support against the thrust.

14. The article sorter as claimed in claim 9 wherein said lower surface has a first protrusion engaged by said first lobe and a second protrusion engaged by said second lobe.

15. The article sorter as claimed in claim 14 wherein said first and second protrusions are generally arcuate in cross section.

16. The article sorter as claimed in claim 1 wherein said motor comprises a motorized roller and wherein said at least one sprocket is mounted to an outer surface of said motorized roller.

17. The article sorter as claimed in claim 1 wherein said at least one sprocket is mounted to a shaft and said motor rotates said shaft.

18. The article sorter as claimed in claim 1 including a wheel assembly supporting each lateral side of said web, each said wheel assembly engaging a lateral end of said slats.

19. The article sorter as claimed in claim 1 including an idler pulley, said idler pulley supporting said web opposite said drive.

20. The article sorter as claimed in claim 19 including a web take-up assembly, said take-up assembly biasing said idler pulley away from said drive assembly.
